(19) United States
(12) Patent Application Publication
(10) Pub. No.: US 2014/0286462 A1
(43) Pub. Date: Sep. 25, 2014

(54) REDUCING ELECTROMAGNETIC INTERFERENCE IN A RECEIVED SIGNAL

(71) Applicant: BROADCOM CORPORATION, Irvine, CA (US)

(72) Inventors: Jiangfeng Wu, San Jose, CA (US); John Lock Creigh, Rancho Santa Margarita, CA (US)

(73) Assignee: Broadcom Corporation, Irvine, CA (US)

(21) Appl. No.: 13/863,873

(22) Filed: Apr. 16, 2013

Related U.S. Application Data
(60) Provisional application No. 61/803,173, filed on Mar. 19, 2013.

(51) Int. Cl. H04B 1/10

(52) U.S. Cl. CPC H04B 1/1027
USPC 375/343

(57) ABSTRACT

Disclosed are various embodiments for reducing the amount of electromagnetic interference (EMI) that may be present in a received signal. A frequency component for the received component is generated. An EMI frequency, an EMI phase, and an EMI amplitude present in the frequency component are tracked. Cancelling data is generated responsive to the EMI frequency, the EMI phase, and the EMI amplitude present in the frequency component.

### CROSS-REFERENCE TO RELATED APPLICATIONS

This application claims the benefit of and priority to U.S. Provisional Application Ser. No. 61/803,173, filed Mar. 19, 2013, which is incorporated by reference herein in its entirety.

### BACKGROUND

In a communication environment, a transmitter communicates signals to a receiver. Due to various factors, electromagnetic interference (EMI) may be present on the signal that is received by the receiver. The EMI may result in data loss or other types of decreased performance for the communication environment.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of an example of a communication environment according to various embodiments of the present disclosure.

FIG. 2 is a drawing of a first example of receiver processing circuitry in the communication environment of FIG. 1 according to various embodiments of the present disclosure.

FIG. 3 is a drawing of an example of electromagnetic interference detection circuitry in the communication environment of FIG. 1 according to various embodiments of the present disclosure.

FIG. 4 is a drawing of an example of electromagnetic interference tracking circuitry in the communication environment of FIG. 1 according to various embodiments of the present disclosure.

FIG. 5 is a drawing of a second example of receiver processing circuitry in the communication environment of FIG. 1 according to various embodiments of the present disclosure.

FIG. 6 is a flowchart illustrating an example of functionality implemented by the receiver processing circuitry in the communication environment of FIG. 1 according to various embodiments of the present disclosure.

### DETAILED DESCRIPTION

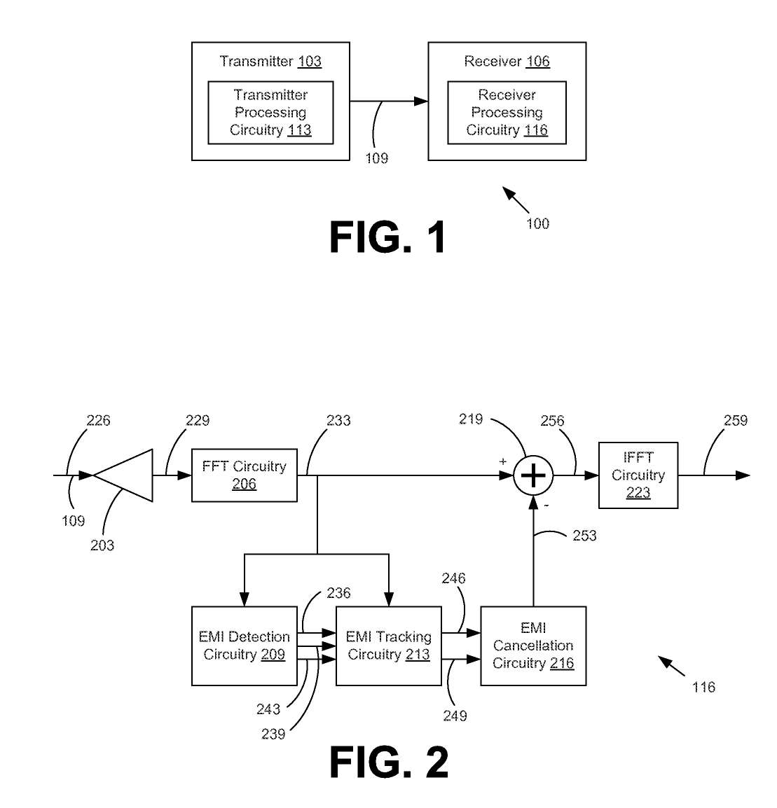

The present disclosure relates to reducing electromagnetic interference (EMI) in a received signal. With reference to FIG. 1, shown is an example of a communication environment 100 according to various embodiments of the present disclosure. The communication environment 100 may be operable to communicate data using the 10GBase-T Ethernet protocol, the 1000Base-T Ethernet protocol, and/or any other type of data communication protocol.

The communication environment 100 in the embodiment shown in FIG. 1 includes a transmitter 103 and a receiver 106 in communication via a communication line 109. Such a communication line 109 may comprise multiple conductive lines to facilitate the transmission and reception of multiple data channels over the communication line 109. As a non-limiting example, such a communication line 109 may be embodied in the form of an Ethernet cable or any other type of conductive medium.

The transmitter 103 is operable to transmit data to the receiver 106. According to various embodiments, the transmitter 103 may comprise a computing device. Such a computing device may be embodied in the form of a desktop computer, a laptop computer, a server computer, a switch, a router, a hub, or any other type of processor-based computing system.

The transmitter 103 comprises transmitter processing circuitry 113 and potentially other components and/or functionality. The transmitter processing circuitry 113 is operable to process and transmit signals over the communication line 109. For example, the transmitter processing circuitry 113 may be operable to format data according to a predetermined protocol being used by the communication environment 100.

The receiver 106 is operable to receive signals that were transmitted on the communication line 109. According to various embodiments, the receiver 106 may comprise a computing device. Such a computing device may be embodied in the form of, for example but not limited to, a desktop computer, a laptop computer, a server computer, a switch, a router, a hub, or any other type of processor-based computing system.

The receiver 106 comprises receiver processing circuitry 116 and potentially other types of components and/or functionality. The receiver processing circuitry 116 may also be operable to provide the received signals and/or associated data to a processor and/or other components in the receiver 106.

It may be the case that an interference source (not shown) is located in the vicinity of the communication environment 100. Such an interference source may be, for example, a wireless transmitter that purposefully radiates wireless signals. As an alternative, an interference source may be a device that unintentionally emits wireless signals. The signals radiated by the interference source may be unintentionally coupled to the communication line 109. As a result, the interference source may cause undesirable EMI to be present in the signals received via the communication line 109. Accordingly, the EMI may degrade the signals that are on the communication line 109 and received by the receiver 106. However, in accordance with various embodiments of the present disclosure, the receiver processing circuitry 116 may adjust the received signals to account for the EMI, as will be discussed below.

With reference to FIG. 2, shown is a portion of the receiver processing circuitry 116 according to various embodiments of the present disclosure. The receiver processing circuitry 116 in the embodiment of FIG. 2 is operable to reduce one or more EMI components while operating in the frequency domain. The receiver processing circuitry 116 in the embodiment of FIG. 2 includes an analog-to-digital converter (ADC) 203, fast Fourier transform (FFT) circuitry 206, EMI detection circuitry 209, EMI tracking circuitry 213, EMI cancellation circuitry 216, a subtractor 219, inverse fast Fourier transform (IFFT) circuitry 223, and potentially other components and/or functionality.

The ADC 203 is operable to convert an analog signal 226 that is received by the receiver processing circuitry 116 into digital time domain data 229. The ADC 203 may employ or be subject to gain control, calibration, and/or other types of operations. The digital time domain data 229 may comprise discrete samples that represent the analog signal 226 in the time domain. Additionally, in various embodiments, the digital time domain data 229 may be subject to various filtering or other types of operations. For instance, the digital time domain data 229 may be subject to a high pass filter, a low pass filter, a bandpass filter, an interpolation filter, or any other type of operation.

The FFT circuitry 206 is operable to perform a fast Fourier transform on the digital time domain data 229 to convert the data into frequency component data 233. The frequency component data 233 may comprise discrete samples that represent the amplitude and phase for the analog signal 226 at particular frequency components.

The EMI detection circuitry 209 is operable to detect whether the frequency component data 233 for one or more of the frequency components comprises an EMI component. In the embodiment of FIG. 2, the EMI detection circuitry 209 outputs an EMI indicator signal 236, frequency component identification data 239, normalized frequency data 243, and/or potentially other data. The EMI indicator signal 236 indicates whether an EMI component has been detected in the frequency component data 233 for one or more of the frequency components. The frequency component identification data 239 identifies the particular one or more frequency components that have been identified as having an EMI component. The normalized frequency data 243 represents the frequency of the detected EMI component.

The EMI tracking circuitry 213 is operable to track one or more detected EMI components. In the embodiment of FIG. 2, the EMI tracking circuitry 213 generates EMI amplitude/phase data 246, EMI frequency data 249, and/or potentially other signals as outputs. The EMI amplitude/phase data 246 comprises information that represents the amplitude and phase of the one or more EMI components detected by the EMI detection circuitry 209. The EMI frequency data 249 comprises information representing the frequency of the one or more EMI components detected by the EMI detection circuitry 209.

The EMI cancellation circuitry 216 is operable to generate cancelling data 253 that is used to reduce the one or more detected EMI components in the frequency component data 233. To this end, the EMI cancellation circuitry 216 may generate cancelling data comprising values that are substantially equal to the one or more EMI components in the frequency component data 233.

The subtractor 219 is operable to subtract values represented in the cancelling data 253 from the frequency component data 233. The subtractor 219 is also operable to generate reduced EMI frequency domain data 256. Such reduced EMI frequency domain data 256 may comprise the frequency component data 233 with the one or more EMI components at least partially removed.

The IFFT circuitry 223 is operable to perform an inverse fast Fourier transform operation to convert data from the frequency domain to the time domain. In particular, the IFFT circuitry 223 in FIG. 2 is operable to convert the reduced EMI frequency domain data 256 to the reduced EMI time domain data 259. The reduced EMI time domain data 259 comprises discrete time-domain samples that represent the analog signal 226 with the EMI at least partially removed.

Next, a discussion of the operation of at least a portion of the receiver processing circuitry 116 is provided. In the following discussion, it is assumed that the transmitter 103 (FIG. 1) is transmitting an analog signal 226 using the communication line 109. Additionally, it is assumed that an interference source is causing EMI to be present in the analog signal 226.

Upon the receiver processing circuitry 116 receiving the analog signal 226, the ADC 203 converts the analog signal 226 into the digital time domain data 229, which comprises discrete samples representing the analog signal 226. The digital time domain data 229 is then provided to the FFT circuitry 206, which converts the digital time domain data 229 into the frequency component data 233. Portions of the frequency component data 233 may correspond to separate frequency components. For embodiments in which the FFT circuitry 206 performs an n-point FFT, the FFT circuitry 206 may generate frequency component data 233 for n/2 frequency components, where n is a predetermined integer. The frequency component data 233 comprises discrete samples that represent the digital time domain data 229 at a particular frequency or frequency range. As shown in FIG. 2, the FFT circuitry 206 then provides the frequency component data 233 to the EMI detection circuitry 209, the EMI tracking circuitry 213, and the subtractor 219.

The EMI detection circuitry 209 receives the frequency component data 233 and performs EMI detection for each of the frequency components, as will be described in more detail below. If the EMI detection circuitry 209 does not detect an EMI component present in any of the frequency components, the EMI detection circuitry 209 generates the EMI indicator signal 236 to indicate that an EMI component is not present in the analog signal 226.

If the EMI detection circuitry 209 does detect that there is an EMI component present in one or more of the frequency components, the EMI detection circuitry 209 generates the EMI indicator signal 236 to indicate that an EMI component was detected. In addition, the EMI detection circuitry 209 generates the frequency component identification data 239 so that it includes information that identifies the one or more frequency components having the one or more detected EMI components. Additionally, the EMI detection circuitry 209 generates the normalized frequency data 243 so that it includes information representing the frequency with a normalized amplitude of each detected EMI component. As will be discussed in more detail later, the EMI tracking circuitry 213 may use the normalized frequency data 243 to track various attributes of a detected EMI component.

If the EMI indicator signal 236 indicates that an EMI component was detected in one or more of the frequency components, the EMI tracking circuitry 213 decides to track the identified one or more EMI components, as will be described in more detail below. For example, the EMI tracking circuitry 213 may track the amplitude, phase, and/or frequency of the detected EMI components. The EMI tracking circuitry 213 in the embodiment of FIG. 2 generates the EMI amplitude/phase data 246 and the EMI frequency data 249 so that they include information describing the tracked amplitude, phase, and/or frequency. The EMI amplitude/phase data 246 and the EMI frequency data 249 are then provided to the EMI cancellation circuitry 216.

The EMI cancellation circuitry 216 then generates the cancelling data 253 responsive to the EMI amplitude/phase data 246 and the EMI frequency data 249. For example, the EMI cancellation circuitry 216 may generate the cancelling data 253 such that the cancelling data 253 comprises substantially the same values as the tracked amplitude, phase, and frequency as indicated by the EMI amplitude/phase data 246 and the EMI frequency data 249. The cancelling data 253 is then provided to the subtractor 219.

The subtractor 219 receives the cancelling data 253 and the frequency component data 233 and subtracts the cancelling data 253 from the frequency component data 233. As a result, the subtractor 219 provides the reduced EMI frequency domain data 256, which represents the frequency component data 233 with the one or more EMI components removed. The reduced EMI frequency domain data 256 is then provided to the IFFT circuitry 223.

The IFFT circuitry 223 receives the reduced EMI frequency domain data 256 and generates the reduced EMI time domain data 259. To this end, the IFFT circuitry 223 may perform an inverse fast Fourier transform on the samples in the reduced EMI frequency domain data 256. The reduced EMI time domain data 259 may comprise discrete samples that represent the analog signal 226 with the EMI at least partially removed. The IFFT circuitry 223 may then provide the reduced EMI time domain data 259 to other components in the receiver processing circuitry 116 for further processing, storage, and/or for other purposes.

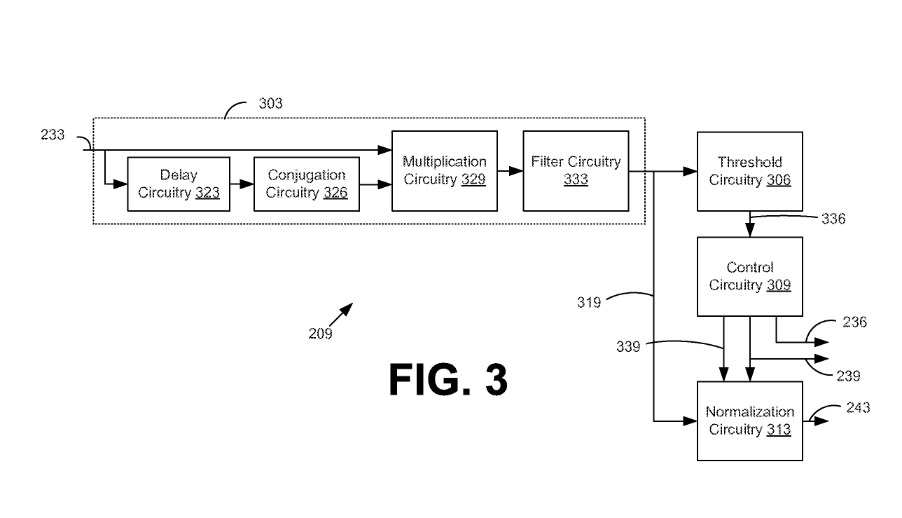

With reference to FIG. 3, shown is a portion of the EMI detection circuitry 209 according to various embodiments of the present disclosure. The EMI detection circuitry 209 in the embodiment shown in FIG. 3 comprises filtered cross-correlation circuitry 303, threshold circuitry 306, control circuitry 309, normalization circuitry 313, and potentially other components. The filtered cross-correlation circuitry 303 is for a particular one of the frequency components of the frequency component data 233 generated by the FFT circuitry 206 (FIG. 1). The filtered cross-correlation circuitry 303 is representative of other filtered cross-correlation circuitry 303 that is for the other frequency components.

The filtered cross-correlation circuitry 303 is operable to receive frequency component data 233 for the corresponding frequency component. The filtered cross-correlation circuitry 303 is also operable to generate filtered cross-correlation data 319. Such filtered cross-correlation data 319 may comprise information that represents the frequency for an EMI component that may be present in the frequency component data 233.

The filtered cross-correlation circuitry 303 in the embodiment shown in FIG. 3 comprises delay circuitry 323, conjugation circuitry 326, multiplication circuitry 329, filter circuitry 333, and potentially other components. The delay circuitry 323 is operable to generate delayed samples of the frequency component data 233.

The conjugation circuitry 326 is operable to generate data representing the complex conjugates of the delayed samples of frequency component data 233. The multiplication circuitry 329 is operable to multiply the complex conjugate by the frequency component data 233. As such, the outputs from the multiplication circuitry 329 are cross-correlations for the frequency component.

The filter circuitry 333 is operable to receive and filter the cross-correlations that are output by the multiplication circuitry 329 to thereby generate the filtered cross-correlation data 319. According to various embodiments, the filter circuitry 333 may apply a low pass filter, an averaging filter, or any other type of suitable filter. Such a filter may comprise an infinite impulse response (IIR) filter or a finite impulse response (FIR) filter, for example.

The threshold circuitry 306 is operable to receive the filtered cross-correlation data 319 and determine whether the amplitude represented in the data exceeds a predetermined threshold. The results of these determinations are represented in the threshold signal 336, which is provided to the control circuitry 309.

The control circuitry 309 controls the operation of portions of the EMI detection circuitry 209 and/or the EMI tracking circuitry 213 (FIG. 2). To this end, in the embodiment shown in FIG. 3, the control circuitry 309 generates an enable signal 339, the EMI indicator signal 236, the frequency component identification data 239, and/or potentially other data. The enable signal 339 identifies whether portions of the normalization circuitry 313 are to be enabled and/or executed.

The normalization circuitry 313 is operable to normalize the values for the frequencies represented in the filtered cross-correlation data 319. In this regard, the normalization circuitry 313 is operable to scale the magnitudes of the values of the filter cross-correlation data 319 so that the values have unity magnitudes.

Next, a discussion of the operation of at least a portion of the EMI detection circuitry 209 is provided. In the following discussion, it is assumed that the FFT circuitry 206 is providing the frequency component data 233 for one of the frequency components to the filtered cross-correlation circuitry 303.

Upon the filtered cross-correlation circuitry 303 receiving the frequency component data 233, the frequency component data 233 is provided to the delay circuitry 323 and to the multiplication circuitry 329. The delay circuitry 323 then generates a delayed version of the samples in the frequency component data 233. Thus, the delay circuitry 323 delays the frequency component data 233.

The delayed versions of the frequency component data 233 are then provided to the conjugation circuitry 326. In turn, the conjugation circuitry 326 generates data representing the complex conjugate of the delayed version of the frequency component data 233.

The output of the conjugation circuitry 326 is then provided to the multiplication circuitry 329. Thereafter, the multiplication circuitry 329 multiplies the value that was output from the conjugation circuitry 326 by the value represented in the first sample of the frequency component data 233. The output from the multiplication circuitry 329 may be represented by the following relationship:

B[n]=A[n]*A[n−m]*, [Equation 1]

where B[n] represents the data output from the multiplication circuitry 329 at time n, A[n] represents a sample from the frequency component data 233 at time n, A[n]* represents the conjugate of A[n], and m represents a predetermined integer.

The output of the multiplication circuitry 329 is then provided to the filter circuitry 333, which performs one or more filtering operations on the data. For example, the filter circuitry 333 may average, apply a low pass filter, and/or perform any other suitable filtering operation across multiple values that have been output by the multiplication circuitry 329. Thus, the filter circuitry 333 generates the filtered cross-correlation data 319 representing a filtered cross-correlation for the frequency component. The filtered cross-correlation data 319 is then provided to the threshold circuitry 306 and to the normalization circuitry 313.

The presence of an EMI component in the frequency component data 233 provided by the FFT circuitry 206 may result in a relatively large amplitude for the filtered cross-correlation data 319 being output from the filtered cross-correlation circuitry 303. As such, the threshold circuitry 306 may identify whether the amplitude of the filtered cross-correlation data 319 exceeds a predetermined threshold. If the value exceeds the predetermined threshold, the threshold circuitry 306 outputs the threshold signal 336 such that it indicates that there is an EMI component present. If the value does not exceed the predetermined threshold, the threshold circuitry 306 outputs the threshold signal 336 such that it indicates that there is not an EMI component present. Thus, the threshold circuitry 306 detects whether an EMI component is present in the corresponding frequency component. The threshold circuitry 306 then provides the threshold signal 336 to the control circuitry 309.

The control circuitry 309 may perform various functionality responsive to the received threshold signal 336. For example, if the threshold signal 336 indicates that an EMI component exists, the control circuitry 309 outputs the EMI indicator signal 236 to indicate the EMI presence. Additionally, if the threshold signal 336 indicates that an EMI component exists, the control circuitry 309 outputs the frequency component identification data 239 to identify the corresponding frequency component. In addition, the control circuitry 309 asserts the enable signal 339 to enable portions of the normalization circuitry 313.

Upon receiving the enable signal 339, the normalization circuitry 313 obtains the filtered cross-correlation data 319 that is associated with an EMI component, as identified by the frequency component identification data 239. The normalization circuitry 313 then scales the value represented in the filtered cross-correlation data 319 so that the value has a unity magnitude. Thus, normalized data comprising information that represents the EMI frequency is generated for the frequency component. The normalization circuitry 313 then outputs the normalized frequency data 243 comprising this normalized data.

The process described above may be performed for each frequency component generated by the FFT circuitry 206. Thus, a normalized signal comprising information that represents the EMI frequency may be generated for each of the frequency components that have been identified as comprising an EMI component.

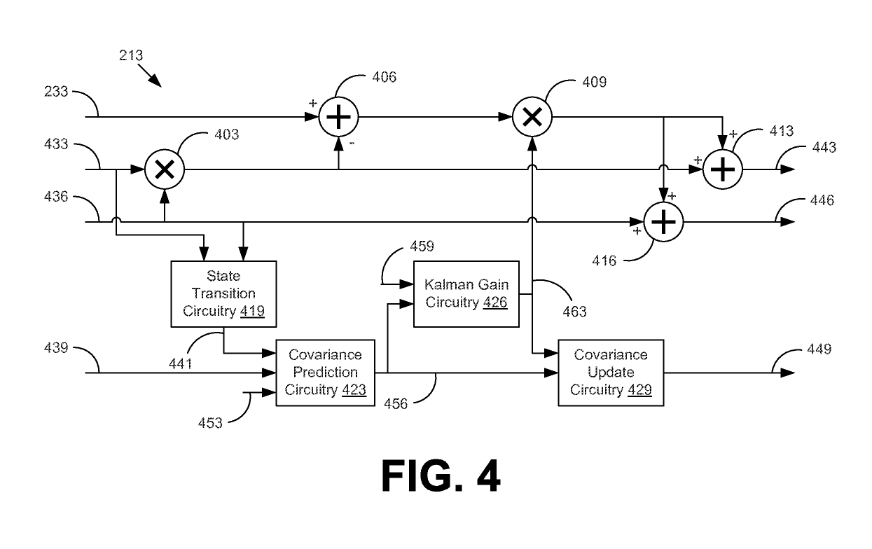

With reference to FIG. 4, shown is an example of a portion of the EMI tracking circuitry 213 according to various embodiments of the present disclosure. The EMI tracking circuitry 213 may obtain initial values for an EMI component, generate predicted values for the EMI component, and generate updated values for the EMI component to track the EMI component. As such, the EMI tracking circuitry 213 may be embodied in the form of an extended Kalman filter in various embodiments.

The EMI tracking circuitry 213 in the embodiment of FIG. 4 comprises a first multiplier 403, a subtractor 406, a second multiplier 409, a first adder 413, a second adder 416, state transition circuitry 419, covariance prediction circuitry 423, Kalman gain circuitry 426, covariance update circuitry 429, and potentially other components and/or functionality. As input parameters, the EMI tracking circuitry 213 receives the frequency component data 233 for the corresponding one of the frequency components, initial EMI amplitude/phase data 433, initial EMI frequency data 436, initial covariance data 439 and potentially other data. The initial EMI amplitude/phase data 433, the initial EMI frequency data 436, and the initial covariance data 439 may represent past or estimated values for characteristics of the EMI component. The initial covariance data 439 comprises the covariance between the initial EMI amplitude/phase data 433 and the initial EMI frequency data 436. The initial EMI amplitude/phase data 433, the initial EMI frequency data 436, and the initial covariance data 439 are used to generate updated EMI amplitude/phase data 443, updated EMI frequency data 446, and updated covariance data 449, as will be discussed below.

The first multiplier 403 is operable to multiply the initial EMI amplitude/phase data 433 by the initial EMI frequency data 436. The subtractor 406 is operable to subtract the value output from the first multiplier 403 from the current value in the frequency component data 233.

The state transition circuitry 419 is operable to generate state transition data 441, such as a state transition matrix, that is used by the extended Kalman filter to generate predicted values for the EMI component. The covariance prediction circuitry 423 is operable to use the state transition data 441, the initial covariance data 439, process noise covariance data 453, and potentially other data to generate predicted covariance data 456. The process noise covariance data 453 comprises data that represents the covariance of the process noise for the extended Kalman filter.

The Kalman gain circuitry 426 is operable to receive the predicted covariance data 456 and measurement noise data 459 to generate Kalman gain data 463. The measurement noise data comprises data representing the noise for the frequency component data 233. The Kalman gain data 463 includes data representing the calculated Kalman gain for the Kalman filter. The Kalman gain circuitry 426 provides the Kalman gain data 463 to the second multiplier 409 and to the covariance update circuitry 429. The covariance update circuitry 429 uses the predicted covariance data 456, the Kalman gain data 463, and/or potentially other information to generate the updated covariance data 449, as will be discussed below.

The second multiplier 409 multiplies the output of the subtractor 406 by the Kalman gain data 463. The first adder 413 sums the output from the second multiplier 409 with the output of the first multiplier 403 to generate the updated EMI amplitude/phase data 443. The second adder 416 sums the initial EMI frequency data 436 with the output from the second multiplier 409 to generate the updated EMI frequency data 446.

Next, a general discussion of the operation of the EMI tracking circuitry 213 is provided. In the following discussion, it is assumed that the EMI detection circuitry 209 is generating the EMI indicator signal 236 (FIG. 2) and the frequency component identification data 239 to indicate that there is an EMI component present in a particular frequency component. Additionally, it is assumed that the FFT circuitry 206 is providing the frequency component data 233 for the identified frequency component to the EMI tracking circuitry 213.

For the first round of generating the updated EMI amplitude/phase data 443 and the updated EMI frequency data 446, the EMI tracking circuitry 213 may use data provided by the EMI detection circuitry 209 (FIG. 3) and the FFT circuitry 206 as the initial parameters for tracking the EMI component. For example, the normalized frequency data 243 (FIG. 3) may be used as the initial EMI frequency data 436 for the first round of generating the updated EMI amplitude/phase data 443 and the updated EMI frequency data 446. Additionally, the current sample of the frequency component data 233 may be used as the initial EMI amplitude/phase data 433 for the first round of generating the updated EMI amplitude/phase data 443 and the updated EMI frequency data 446. In alternative embodiments, an average of multiple samples of the frequency component data 233 multiplied by the normalized frequency data 243 may be used as the initial EMI amplitude/phase data 433 for the first round of generating the updated EMI amplitude/phase data 443 and the updated EMI frequency data 446. In further embodiments, arbitrary values, such as 0, may be used as the initial values for the initial EMI amplitude/phase data 433 and/or the initial EMI frequency data 436.

With the initial EMI amplitude/phase data 433 and the initial EMI frequency data 436 determined for the first extended Kalman filtering cycle, this information is provided to the first multiplier 403. The first multiplier 403 then multiplies the initial EMI amplitude/phase data 433 by the initial EMI frequency data 436. Thus, the output of the first multiplier 403 may be expressed using the following equation:

X1[n]=X1[n−1]*X2[n−1], [Equation 2]

where X1[n] represents the output of the first multiplier 403, X1[n−1] represents the value of the initial EMI amplitude/phase data 433, and X2[n−1] represents the value of the initial EMI frequency data 436. The output of the first multiplier 403 may be regarded as being a predicted value of the EMI amplitude/phase for the EMI component. The output of the first multiplier 403 is then provided to the subtractor 406, the first adder 413, and the state transition circuitry 419.

The subtractor 406 then subtracts the output of the first multiplier 403 from the frequency component data 233. Thus, the subtractor 406 may be regarded as subtracting the estimated EMI amplitude/phase from the current sample of the frequency component data 233. This data is then output from the subtractor 406 to the second multiplier 409.

The state transition circuitry 419 receives the initial EMI amplitude/phase data 433 and the initial EMI frequency data 436 and generates the state transition data 441. The state transition data 441 may comprise the state transition matrix for the extended Kalman filter. For example, the state transition data 441 may be represented using the following equation:

$$F = [ \begin{matrix}X 2 [ n - 1 ] & X 1 [ n - 1 ] \\ 0 & 1\end{matrix} ] , \qquad [ Equation 3 ]$$

where F represents the state transition data 441, X2[n−1] represents the value of the initial EMI frequency data 436, and X1[n−1] represents the value of the initial EMI amplitude/phase data 433. The state transition data 441 is then provided to the covariance prediction circuitry 423.

The covariance prediction circuitry 423 receives the state transition data 441, the initial covariance data 439, the process noise covariance data 453, and potentially other data and generates the predicted covariance data 456. In embodiments operable to perform floating point operations, the predicted covariance data 456 may be represented using, for example, the following equation:

P_{pred}=F*P*F′+Q, [Equation 4]

where P_{pred} represents the predicted covariance data 456, F represents the state transition data 441, P represents the initial covariance data 439, and Q represents the process noise covariance data 453. In embodiments operable to perform fixed point operations, the predicted covariance data may be represented using, for example, the following equation:

$${P}_{pred} = [ \begin{matrix}1 & U 12 \\ 0 & 1\end{matrix} ] [ \begin{matrix}D 11 & 0 \\ 0 & D 22\end{matrix} ] [ \begin{matrix}1 & 0 \\ U {12}^{*} & 1\end{matrix} ] , \qquad [ Equation 5 ]$$

where P_{pred} represents the predicted covariance data 456 and U12, D11, and D22 represent the components that are to be determined. The predicted covariance data 456 is then provided to the Kalman gain circuitry 426 and to the covariance update circuitry 429.

The Kalman gain circuitry 426 then receives the predicted covariance data 456, the measurement noise data 459, and potentially other data and determines the Kalman gain that minimizes the variance of the estimation error for the Kalman filter. To this end, the Kalman gain circuitry 426 may use equation 4 or equation 5 so that the variance of the estimation error for the Kalman filter is minimized. Upon the Kalman gain being determined, the Kalman gain circuitry 426 outputs this information as the Kalman gain data 463. The Kalman gain circuitry 426 then provides the Kalman gain data 463 to the second multiplier 409 and to the covariance update circuitry 429.

The covariance update circuitry 429 receives the Kalman gain data 463, the predicted covariance data 456, and potentially other data and generates the updated covariance data 449. For example, the updated covariance data 449 may be represented by the following equation:

P_{updated}=(1−K*[1 0])*P_{pred}, [Equation 6]

where P_{updated} represents the updated covariance data 449, K represents the Kalman gain data 463, and P_{pred} represents the predicted covariance data 456. The updated covariance data 449 is then fed back to the covariance prediction circuitry 423 to be used as the initial covariance data 439 for the next extended Kalman filtering cycle.

The second multiplier 409 receives Kalman gain data 463 and the output from the subtractor 406. The Kalman gain data 463 is then multiplied by the output from the subtractor 406 and then provided to the first adder 413 and to the second adder 416.

The first adder 413 sums the output from the second multiplier 409 with the output from the first multiplier 403. The output from the first adder 413 is then provided as the updated EMI amplitude/phase data 443. The updated EMI amplitude/phase data 443 is then provided to the EMI cancellation circuitry 216. Additionally, the updated EMI amplitude/phase data 443 is fed back to the first multiplier 403 for use as the initial EMI amplitude/phase data 433 for the next Kalman filtering cycle.

The second adder 416 sums the output from the second multiplier 409 with the initial EMI frequency data 436. The result of this summation is then output by the second adder 416 as the updated EMI frequency data 446. The updated EMI frequency data 446 is then provided to the EMI cancellation circuitry 216. Additionally, the updated EMI frequency data 446 is fed back to the first multiplier 403, the state transition circuitry 419, and the second adder 416 for use as the initial EMI frequency data 436 for the next Kalman filtering cycle.

The process of generating the updated EMI amplitude/phase data 443, the updated EMI frequency data 446, and the updated covariance data 449 may be repeated. In particular, the process may be repeated using the previously determined values for the updated EMI amplitude/phase data 443, the updated EMI frequency data 446, and the updated covariance data 449 as the initial EMI amplitude/phase data 433, the initial EMI frequency data 436, and the initial covariance data 439, respectively. Thus, the EMI tracking circuitry 213 tracks the detected EMI component for the received analog signal 226 (FIG. 1).

If multiple EMI components were detected, the process described above may also be repeated for each detected EMI component. Thus, the EMI tracking circuitry 213 may track multiple detected EMI components for the received analog signal 226.

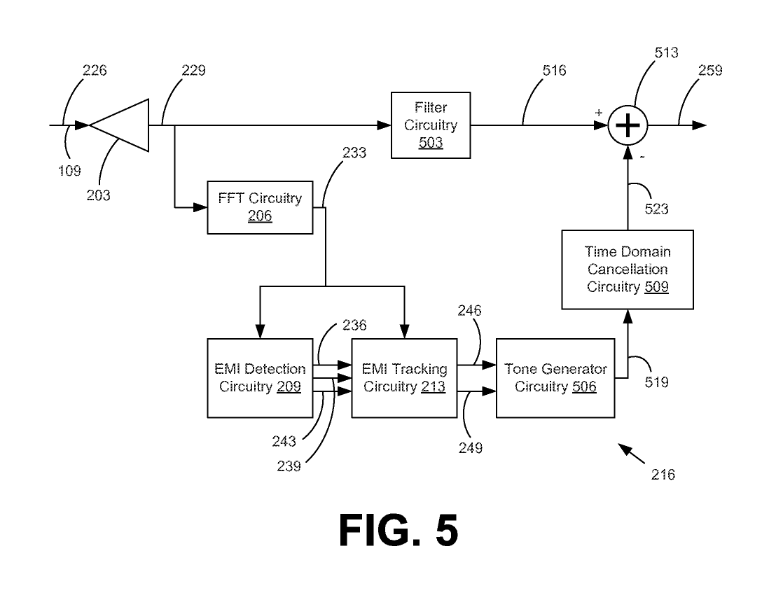

With reference to FIG. 5, shown is a portion of another example of the receiver processing circuitry 116 according to various embodiments of the present disclosure. The receiver processing circuitry 116 in the embodiment of FIG. 5 is operable to reduce one or EMI components while operating in the time domain. The receiver processing circuitry 116 in the embodiment of FIG. 5 is similar to the embodiment of FIG. 2 discussed above. For example, the receiver processing circuitry 116 in the embodiment of FIG. 5 comprises the ADC 203, the FFT circuitry 206, the EMI detection circuitry 209, and the EMI tracking circuitry 213. The receiver processing circuitry 116 in the embodiment of FIG. 5 also comprises filter circuitry 503, tone generator circuitry 506, time domain cancellation circuitry 509, a subtractor 513, and potentially other components.

The filter circuitry 503 is operable to perform filtering operations on the digital time domain data 229. For example, the filter circuitry 503 may be embodied in the form of an equalizing filter or any other type of suitable filter that generates filtered time domain data 516. The tone generator circuitry 506 is operable to receive the EMI amplitude/phase data 246, the EMI frequency data 249, and/or potentially other data and generate tone data 519. The tone data 519 may be a time domain representation of the one or more EMI components that were tracked by the EMI tracking circuitry 213. The time domain cancellation circuitry 509 receives the tone data 519 and generates time domain cancellation data 523 responsive to the tone data 519. The subtractor 513 is operable to subtract the time domain cancellation data 523 from the filtered time domain data 516 to generate the reduced EMI time domain data 259.

Next, a general discussion of the operation of the receiver processing circuitry 116. In the following discussion, it is assumed that the receiver processing circuitry 116 is receiving an analog signal 226 on the communication line 109. Additionally, it is assumed that the EMI tracking circuitry 213 is providing the EMI amplitude/phase data 246 and the EMI frequency data 249 as discussed above.

In addition to providing the digital time domain data 229 to the FFT circuitry 206, the ADC 203 provides the digital time domain data 229 to the filter circuitry 503. The filter circuitry 503 may equalize and/or perform other types of filtering operations on the digital time domain data 229 to generate the filtered time domain data 516. The filtered time domain data 516 is then provided to the subtractor 513.

The EMI tracking circuitry 213 provides the EMI amplitude/phase data 246 and the EMI frequency data 249 to the tone generator circuitry 506. The tone generator circuitry 506 uses the EMI amplitude/phase data 246, the EMI frequency data 249, and potentially other data to generate the tone data 519. According to various embodiments, the tone data 519 may represent the one or more tracked EMI components in the time domain. The tone data 519 is then provided to the time domain cancellation circuitry 509.

The time domain cancellation circuitry 509 uses the tone data 519 to generate the time domain cancellation data 523. The time domain cancellation circuitry 509 may, for example, perform adaptive filtering in order to generate the time domain cancellation data 523 such that the mean squared error for the resulting reduced EMI time domain data 259 is minimized. The time domain cancellation data 523 is then provided to the subtractor 513.

The subtractor 513 receives the filtered time domain data 516 and the time domain cancellation data 523 and generates the reduced EMI time domain data 529. To this end, the subtractor 513 may subtract the time domain cancellation data 523 from the filtered time domain data 516. The resulting reduced EMI time domain data 259 may then be provided to other components in the receiver 106 (FIG. 1) for further processing, storage, and/or other purposes.

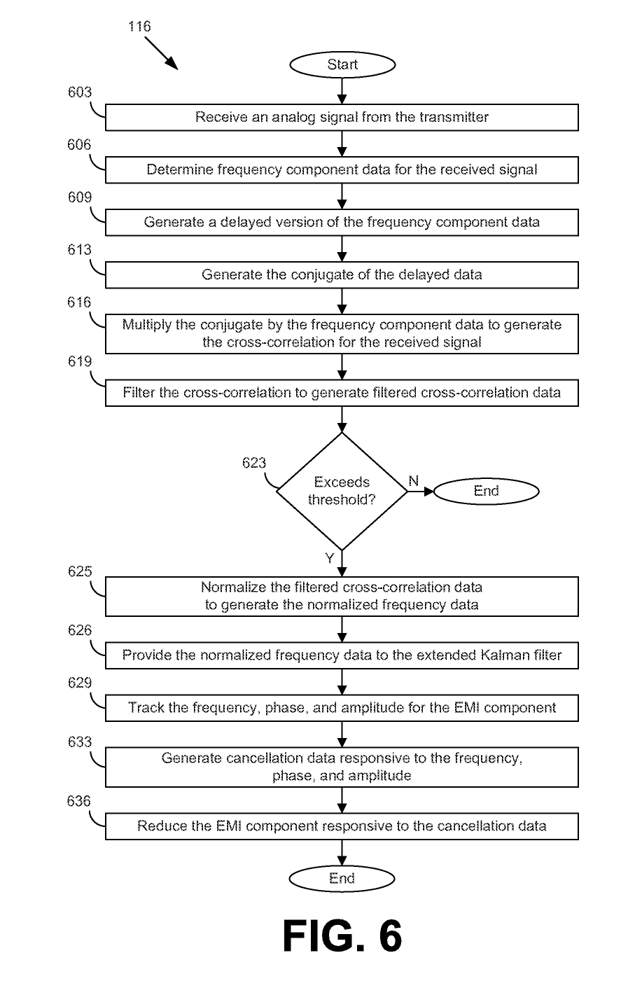

With reference to FIG. 6, shown is a flowchart illustrating an example of at least a portion of the functionality implemented by the receiver processing circuitry 116 according to various embodiments of the present disclosure. In particular, the flowchart of FIG. 6 illustrates an example of the receiver processing circuitry 116 reducing an EMI component present in a received signal. It is understood that the flowchart of FIG. 6 provides merely an example of the many different types of functionality that may be implemented by the receiver processing circuitry 116 as described herein. Additionally, the flowchart of FIG. 6 may be viewed as depicting an example of steps of a method implemented in the receiver 106 (FIG. 1) according to one or more embodiments.

Beginning at reference number 603, receiver processing circuitry 116 receives an analog signal 226 (FIG. 2) from the transmitter 103 (FIG. 1). The receiver processing circuitry 116 then determines the frequency component data 233 (FIG. 2) for the analog signal 226, as indicated at reference number 606. To this end, the receiver processing circuitry 116 may use the ADC 203 to convert the analog signal 226 to the digital time domain data 229 and then use the FFT circuitry 206 to generate the frequency component data 233 for a frequency component.

As shown at reference number 609, the receiver processing circuitry 116 then generates a delayed version of the frequency component data 233. For example, the delay circuitry 323 (FIG. 3) may generate the delayed version of the frequency component data 233. The receiver processing circuitry 116 then generates the conjugate of the delayed version of the frequency component data 233, as indicated at reference number 613. To this end, the conjugation circuitry 326, for example, may determine the complex conjugate of the delayed version of the frequency component data 233.

Next, as shown at reference number 616, the conjugate is multiplied by the frequency component data 233 to generate the cross-correlation. According to various embodiments, the multiplication circuitry 329 may perform this multiplication operation. The receiver processing circuitry 116 then filters the cross-correlation to generate the filtered cross-correlation data 319 (FIG. 3), as shown at reference number 619. To this end, the filter circuitry 333 (FIG. 3), for example, may apply an averaging filter, a low pass filter, and/or any other type of suitable filter.

The receiver processing circuitry 116 then determines whether the amplitude of the filtered cross-correlation data 319 exceeds a predetermined threshold, as shown at reference number 623. For example, the threshold circuitry 306 may determine whether the amplitude exceeds the predetermined threshold. If the amplitude does not exceed the predetermined threshold, the process ends.

As shown at reference number 625, if the amplitude does exceed the predetermined threshold, the receiver processing circuitry 116 normalizes the filtered cross-correlation data 319 to generate the normalized frequency data 243 (FIG. 3). The normalized frequency data 243 may include information representing the frequency of the EMI component with a normalized amplitude. As indicated at reference number 626, the receiver processing circuitry 116 then provides the normalized frequency data 243 to the extended Kalman filter, such as the one represented in FIG. 4. The frequency, phase, and amplitude for the detected EMI component are then tracked using the extended Kalman filter, as indicated at reference number 629.

The receiver processing circuitry 116 then generates the cancelling data 253 (FIG. 2), as indicated at reference number 633. The EMI component is then reduced responsive to the cancelling data 253, as shown at reference number 636. For instance, the cancelling data 253 may be provided to the subtractor 219 (FIG. 2) in order to reduce the EMI component. Thereafter, the process ends.

Although the flowchart of FIG. 6 shows a specific order of execution, it is understood that the order of execution may differ from that which is depicted. For example, the order of execution of two or more items may be switched relative to the order shown. Also, two or more items shown in succession may be executed concurrently or with partial concurrence. Further, in some embodiments, one or more of the items shown may be skipped or omitted. Additionally, one or more items shown in one flow chart may be executed concurrently or partially concurrently with one or more items shown in another flowchart. In addition, any number of elements might be added to the logical flow described herein, for purposes of enhanced utility, accounting, performance measurement, providing troubleshooting aids, etc. It is understood that all such variations are within the scope of the present disclosure.

The components described herein may be implemented by circuitry. In this regard, such circuitry may be arranged to perform the various functionality described above by generating and/or responding to electrical or other types of signals. The circuitry may be general purpose hardware or hardware that is dedicated to performing particular functions. The circuitry may include, but is not limited to, discrete components, integrated circuits, or any combination of discrete components and integrated circuits. Such integrated circuits may include, but are not limited to, one or more microprocessors, system-on-chips, application specific integrated circuits, digital signal processors, microcomputers, central processing units, programmable logic devices, state machines, other types of devices, and/or any combination thereof. The circuitry may also include interconnects, such as lines, wires, traces, metallization layers, or any other element through which components may be coupled. Additionally, the circuitry may be configured to execute software to implement the functionality described herein.

Also, components and/or functionality described herein, including the receiver processing circuitry 116, can be embodied in any computer-readable medium, such as a non-transitory medium or a propagation medium, for use by or in connection with a system described herein. In this sense, the logic may comprise, for example, statements including instructions and declarations that can be fetched from the computer-readable medium and executed by the instruction execution system. In the context of the present disclosure, a “computer-readable medium” can be any medium that can propagate, contain, store, or maintain the logic, functionality, and/or application described herein.

The computer-readable medium can comprise any one of many physical media such as, for example, magnetic, optical, or semiconductor media. More specific examples of a suitable computer-readable medium may include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM), dynamic random access memory (DRAM), and/or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It is emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A system, comprising:
a receiver comprising circuitry operable to:
generate frequency component data for a received signal;
generate an initial electromagnetic interference (EMI) frequency value for the frequency component data;
detect whether a filtered cross-correlation for the frequency component data exceeds a predetermined threshold;
in response to the filtered cross-correlation exceeding the predetermined threshold, track an EMI frequency, an EMI phase, and an EMI amplitude present in the frequency component data using the initial EMI frequency value;
generate cancellation data responsive to the EMI frequency, the EMI phase, and the EMI amplitude; and
reduce an EMI component associated with the received signal responsive to the cancellation data.

2. The system of claim 1, wherein the circuitry is further operable to:
generate a delayed version of the frequency component data;
generate a conjugate of the delayed version of the frequency component data;
multiply the frequency component data with the conjugate of the delayed version to generate a cross-correlation of the frequency component data; and
filter the cross-correlation to generate the filtered cross-correlation.

3. The system of claim 2, wherein the filtered cross-correlation comprises an averaged cross-correlation.

4. The system of claim 1, wherein the circuitry operable to track the EMI frequency, the EMI phase, and the EMI amplitude present in the frequency component data comprises an extended Kalman filter.

5. The system of claim 4, wherein the extended Kalman filter uses a normalized version of the filtered cross-correlation as the initial EMI frequency value to track the EMI frequency, the EMI phase, and the EMI amplitude present in the frequency component data.

6. The system of claim 1, wherein the circuitry is operable to perform a fast Fourier transform to generate the frequency component data.

7. A method, comprising:
generating, using a receiver, frequency component data for a received signal;
identifying, using the receiver, whether an electromagnetic interference (EMI) component present in the frequency component data exceeds a predetermined threshold;
in response to the EMI component exceeding the predetermined threshold, tracking, using the receiver, a frequency, a phase, and an amplitude for the EMI component;
generating, using the receiver, cancellation data responsive to the frequency, the phase, and the amplitude; and
reducing, using the receiver, the EMI component responsive to the cancellation data.

8. The method of claim 7, wherein identifying whether the EMI component present in the frequency component data exceeds the predetermined threshold further comprises detecting whether a filtered cross-correlation for the frequency component data exceeds the predetermined threshold.

9. The method of claim 7, wherein identifying whether the EMI component present in the frequency component data exceeds the predetermined threshold further comprises:
generating a delayed version of the frequency component data;
generating a conjugate of the delayed version;
multiplying the frequency component data with the conjugate of the delayed version to generate a cross-correlation for the frequency component data;
filtering the cross-correlation to generate a filtered cross-correlation; and
detecting whether the filtered cross-correlation exceeds the predetermined threshold.

10. The method of claim 7, further comprising:
generating a filtered cross-correlation for the frequency component data; and
applying an extended Kalman filter using a normalized version of the filtered cross-correlation.

11. The method of claim 7, wherein generating the frequency component data for the received signal further comprises performing a fast Fourier transform.

12. The method of claim 7, wherein reducing the EMI component is performed in a time domain.

13. The method of claim 7, wherein reducing the EMI component is performed in a frequency domain.

14. An apparatus, comprising:
circuitry operable to:
obtain frequency component data for a received signal that was transmitted by a receiver;
track a frequency, a phase, and an amplitude present in the frequency component data; and
generate cancelling data responsive to the frequency, the phase, and the amplitude to reduce an electromagnetic interference component for the received signal.

15. The apparatus of claim 14, wherein the circuitry is further operable to:
generate a filtered cross-correlation for the frequency component data; and
track the frequency, the phase, and the amplitude using the filtered cross-correlation as an initial tracking parameter.

16. The apparatus of claim 15, wherein the filtered cross-correlation comprises an averaged cross-correlation.

17. The apparatus of claim 15, wherein the circuitry is further operable to:
detect whether the filtered cross-correlation exceeds a predetermined threshold; and
in response to the filtered cross-correlation exceeding the predetermined threshold, initiate tracking the frequency, the phase, and the amplitude.

18. The apparatus of claim 15, wherein the circuitry is further configured to:
generate a delayed version of the frequency component data;
generate a conjugate of the delayed version;
multiply the frequency component data with the conjugate of the delayed version to generate a cross-correlation for the frequency component data; and
filter the cross-correlation to generate the filtered cross-correlation.

19. The apparatus of claim 14, wherein the circuitry is further operable to reduce the electromagnetic interference component.

20. The apparatus of claim 14, wherein the circuitry is further operable to adjust the received signal to reduce the electromagnetic interference component.
